(19) United States
(12) Patent Application Publication
(10) Pub. No.: US 2025/0330950 A1
(43) Pub. Date: Oct. 23, 2025

(54) ON-BOARD WIRELESS DEVICE

(71) Applicant: Mitsubishi Electric Corporation, Tokyo (JP)

(72) Inventor: Daichi UCHINO, Tokyo (JP)

(73) Assignee: Mitsubishi Electric Corporation, Tokyo (JP)

(21) Appl. No.: 19/256,416

(22) Filed: Jul. 1, 2025

Related U.S. Application Data
(63) Continuation of application No. PCT/JP2023/007555, filed on Mar. 1, 2023.

(51) Int. Cl. H04W 64/00; H04W 24/10; H04W 84/00

(52) U.S. Cl. CPC H04W 64/006; H04W 24/10; H04W 84/005

(57) ABSTRACT

An on-board wireless device to be installed in a train includes: a local 5G terminal and a carrier 5G terminal that are communication units capable of transmitting and receiving data to and from a base station by a wireless communication scheme using an antenna having directivity in a traveling direction; a sidelink terminal that is a communication unit capable of transmitting and receiving data to and from an on-board wireless device installed in another train using wireless communication by sidelink; a determination unit that determines a communication unit to be used for transmission and reception of data based on a communication environment of the train at a position of the train; and a train gateway that controls transmission and reception of data in the local 5G terminal, the carrier 5G terminal, and the sidelink terminal based on a determination result of the determination unit.

### CROSS-REFERENCE TO RELATED APPLICATION

This application is a continuation application of International Application PCT/JP2023/007555, filed on Mar. 1, 2023, and designating the U.S., the entire contents of which are incorporated herein by reference.

### BACKGROUND OF THE INVENTION

### 1. Field of the Invention

The present disclosure relates to an on-board wireless device that is installed in a train.

### 2. Description of the Related Art

Conventionally, in transportation infrastructures such as railways and automobiles, tunnels are used to maintain the line shape of routes such as tracks and roads. Examples of methods for performing wireless communication inside a tunnel include a method of installing a base station inside the tunnel and a method of transmitting a radio wave from a base station outside the tunnel to the inside of the tunnel. When the tunnel wall surface is close to an object traveling inside the tunnel, it is difficult to install a base station inside the tunnel. Therefore, the method of transmitting a radio wave from a base station outside the tunnel to the inside of the tunnel is used.

In order to avoid a situation in which a vehicle traveling inside a tunnel obstructs synchronization between base stations by shielding a synchronization signal between base stations at tunnel ends, PCT Patent Application Laid-open No. 2013/047450 discloses a technique in which wireless devices installed in front and rear parts of a vehicle relay a synchronization signal from a base station to maintain a synchronization state between base stations. Even in a case where a plurality of vehicles exist inside the tunnel, the vehicles described in PCT Patent Application Laid-open No. 2013/047450 can maintain a synchronization state between base stations by relaying a synchronization signal between the vehicles, and can also transmit and receive necessary data to and from the base stations.

However, according to the above conventional technique, in a vehicle traveling inside a tunnel, it is necessary to operate wireless devices installed in front and rear parts of the vehicle. This is problematic in that the technique cannot be applied to a vehicle that uses only a wireless device in the traveling direction of the vehicle due to a specification reason or the like.

### SUMMARY OF THE INVENTION

In order to solve the above-described problems and achieve the object, an on-board wireless device according to the present disclosure is to be installed in a train. The on-board wireless device includes: a first communication unit that is a communication unit capable of transmitting and receiving data to and from a base station by a wireless communication scheme of a 5th generation mobile communication system using an antenna having directivity in a traveling direction of the train; a second communication unit that is a communication unit capable of transmitting and receiving data to and from an on-board wireless device installed in an other train using wireless communication by sidelink; a determination unit to determine a communication unit to be used for transmission and reception of data based on a communication environment of the train at a position of the train; and a communication control unit to control transmission and reception of data in the first communication unit and the second communication unit based on a determination result of the determination unit.

### BRIEF DESCRIPTION OF THE DRAWINGS

FIG. 1 is a first diagram illustrating a communication state in which trains according to the first embodiment are traveling in a tunnel;

FIG. 2 is a second diagram illustrating a communication state in which the trains according to the first embodiment are traveling in the tunnel;

FIG. 3 is a third diagram illustrating a communication state in which the trains according to the first embodiment are traveling in the tunnel;

FIG. 4 is a diagram illustrating an exemplary configuration of an on-board wireless device according to the first embodiment;

FIG. 5 is a diagram illustrating a flow of data transmitted and received by the on-board wireless device according to the first embodiment;

FIG. 6 is a diagram illustrating an exemplary configuration of a 5G system according to the first embodiment;

FIG. 7 is a diagram illustrating a connection relationship between the application function (AF) connected to the 5G core and the command center according to the first embodiment;

FIG. 8 is a flowchart illustrating the operation of the on-board wireless device according to the first embodiment;

FIG. 9 is a diagram illustrating an exemplary configuration of processing circuitry in the case that the processing circuitry that implements the on-board wireless device according to the first embodiment is implemented by a processor and a memory;

FIG. 10 is a diagram illustrating an example of processing circuitry in the case that the processing circuitry that implements the on-board wireless device according to the first embodiment is implemented by dedicated hardware;

FIG. 11 is a first diagram illustrating a state in which the trains equipped with the on-board wireless devices are left in a train yard according to the second embodiment; and

FIG. 12 is a second diagram illustrating a state in which the trains equipped with the on-board wireless devices are left in the train yard according to the second embodiment.

### DETAILED DESCRIPTION OF THE PREFERRED EMBODIMENTS

Hereinafter, an on-board wireless device according to embodiments of the present disclosure will be described in detail with reference to the drawings.

### First Embodiment

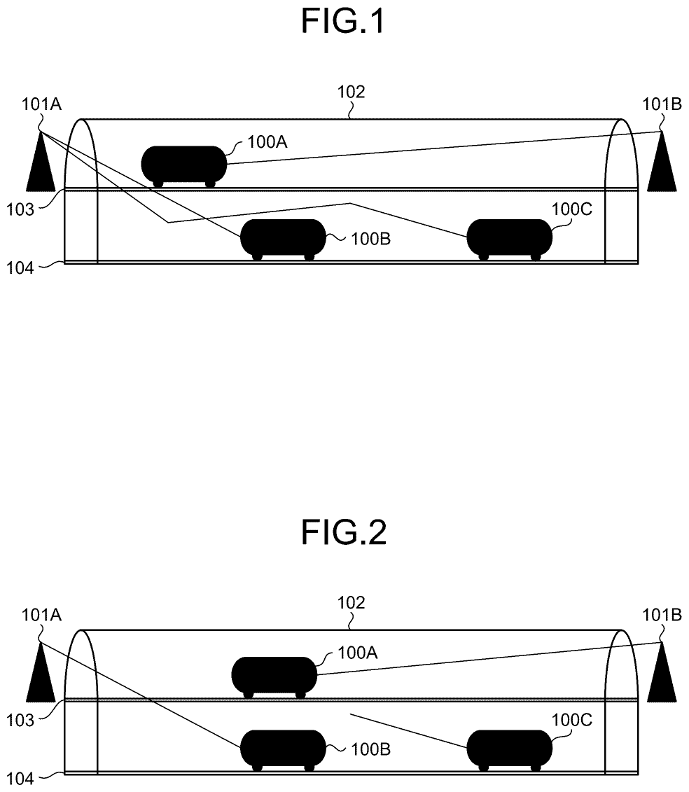

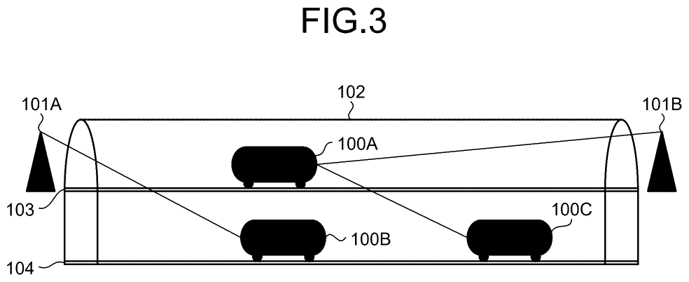

First, an outline of a communication state between a train and a base station assumed in the first embodiment will be described. FIG. 1 is a first diagram illustrating a communication state in which trains 100A, 100B, and 100C according to the first embodiment are traveling in a tunnel 102. FIG. 2 is a second diagram illustrating a communication state in which the trains 100A, 100B, and 100C according to the first embodiment are traveling in the tunnel 102. FIG. 3 is a third diagram illustrating a communication state in which the trains 100A, 100B, and 100C according to the first embodiment are traveling in the tunnel 102. The trains 100A, 100B, and 100C may be a group consisting of a plurality of cars or may be a single train consisting of only one car. It is assumed that each of the trains 100A, 100B, and 100C is equipped with an on-board wireless device described later.

In FIGS. 1 to 3, the train 100A travels inside the tunnel 102 on an inbound line 103 with the right side in FIGS. 1 to 3 as the traveling direction. The trains 100B and 100C travel inside the tunnel 102 on an outbound line 104 with the left side in FIGS. 1 to 3 as the traveling direction. Further, a base station 101A is installed at the entrance of the inbound line 103 of the tunnel 102 and the exit of the outbound line 104, and a base station 101B is installed at the entrance of the outbound line 104 of the tunnel 102 and the exit of the inbound line 103. In the following description, the trains 100A, 100B, and 100C may be referred to as the train 100 when not distinguished, and the base stations 101A and 101B may be referred to as the base station 101 when not distinguished. As illustrated in FIGS. 1 to 3, both ends of the tunnel 102 are stations or places where the base station 101 can be installed. Each of the base stations 101A and 101B transmits a radio wave into the tunnel 102.

The train 100A is equipped with an on-board wireless device antenna (not illustrated) that is used for communication with the base station 101 on the front part of the train 100A, that is, on the traveling direction side, and thus can communicate with the base station 101B. The train 100B is equipped with an on-board wireless device antenna (not illustrated) that is used for communication with the base station 101 on the front part of the train 100B, that is, on the traveling direction side, and thus can communicate with the base station 101A. Similarly, the train 100C is equipped with an on-board wireless device antenna (not illustrated) that is used for communication with the base station 101 on the front part of the train 100C, that is, on the traveling direction side, and thus can communicate with the base station 101A.

In FIGS. 1 to 3, the train 100A can continuously communicate with the base station 101B, and the train 100B can continuously communicate with the base station 101A. On the other hand, the train 100C can communicate with the base station 101A in the situation as illustrated in FIG. 1, but as illustrated in FIG. 2, the trains 100A, 100B, and 100C move with time and the positional relationship among the trains 100A, 100B, and 100C changes, and at the timing when the trains 100A and 100B pass each other, the train 100C becomes unable to communicate with the base station 101A due to shielding of the trains 100A and 100B. Therefore, as illustrated in FIG. 3, the train 100C communicates with the base station 101B via the train 100A, thereby avoiding communication disconnection.

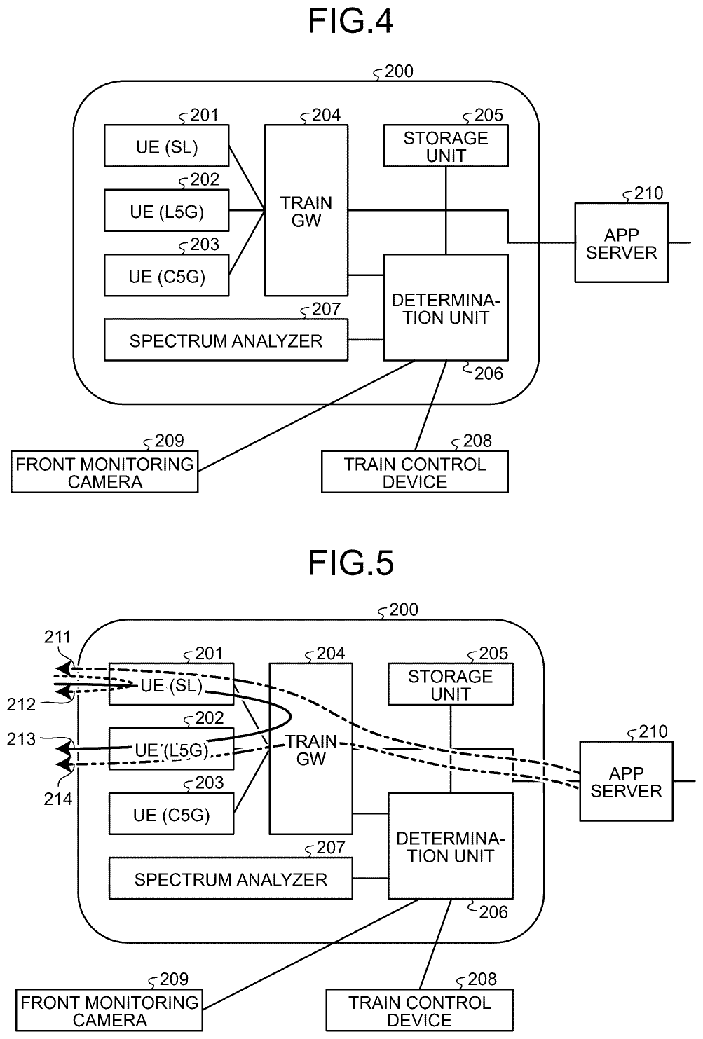

The configuration and operation of the on-board wireless device installed in the train 100 will be described. FIG. 4 is a diagram illustrating an exemplary configuration of an on-board wireless device 200 according to the first embodiment. The trains 100A, 100B, and 100C illustrated in FIGS. 1 to 3 are each equipped with the on-board wireless device 200 illustrated in FIG. 4. The on-board wireless device 200 includes a sidelink terminal 201, a local 5G terminal 202, a carrier 5G terminal 203, a train gateway 204, a storage unit 205, a determination unit 206, and a spectrum analyzer 207. The on-board wireless device 200 is connected to a train control device 208, a front monitoring camera 209, and an app server 210.

The train control device 208 controls the operation of the train 100 in which the on-board wireless device 200 is installed. The train control device 208 periodically outputs information such as speed information of the train 100 and position information of the train 100 to the determination unit 206 of the on-board wireless device 200. Since the determination unit 206 of the on-board wireless device 200 only needs to periodically acquire information such as the speed information of the train 100 and the position information of the train 100, information such as the speed information of the train 100 and the position information of the train 100 may be acquired from a device different from the train control device 208. In addition, the determination unit 206 of the on-board wireless device 200 may acquire the speed information of the train 100 and the position information of the train 100 from different devices. In addition, the determination unit 206 of the on-board wireless device 200 may calculate the speed of the train 100 by acquiring information from which the speed of the train 100 can be calculated, or may calculate the position of the train 100 by acquiring information from which the position of the train 100 can be calculated.

The front monitoring camera 209 is installed in front of the train 100 and monitors the area ahead of the train 100, that is, the traveling direction of the train 100. The front monitoring camera 209 outputs the captured video of the traveling direction of the train 100 to the determination unit 206 of the on-board wireless device 200.

The app server 210 accumulates and manages data and the like transmitted from the train 100 to the base station 101, and outputs the data to the train gateway 204 of the on-board wireless device 200. Further, the app server 210 performs control to acquire data received by the sidelink terminal 201, the local 5G terminal 202, or the carrier 5G terminal 203 from the train gateway 204 of the on-board wireless device 200 and distribute the data to a display device (not illustrated) or the like in the train 100.

The sidelink terminal 201 is a communication unit capable of transmitting and receiving data to and from the sidelink terminal 201 of the on-board wireless device 200 installed in another train 100 by means of wireless communication by sidelink. In FIG. 4, the sidelink terminal 201 is denoted by user equipment (UE) (sidelink (SL)) 201. The sidelink terminal 201 outputs the received data to the train gateway 204, and transmits the data acquired from the train gateway 204 to the sidelink terminal 201 of the on-board wireless device 200 installed in another train 100.

The local 5G terminal 202 is a communication unit capable of transmitting and receiving data to and from the base station 101 by a wireless communication scheme of the 5th generation mobile communication system (hereinafter referred to as 5G) using an antenna (not illustrated) having directivity in the traveling direction of the train 100. In FIG. 4, the local 5G terminal 202 is denoted by UE (local (L) 5G) 202. The local 5G terminal 202 uses, for example, a 5G service provided by a railroad company or the like that operates the train 100. The local 5G terminal 202 outputs the received data to the train gateway 204, and transmits the data acquired from the train gateway 204 to the base station 101.

The carrier 5G terminal 203 is a communication unit capable of transmitting and receiving data to and from the base station 101 by a 5G wireless communication scheme using an antenna (not illustrated) having directivity in the traveling direction of the train 100. In FIG. 4, the carrier 5G terminal 203 is denoted by UE (carrier (C) 5G) 203. The carrier 5G terminal 203 uses, for example, a 5G service provided by a communication carrier or the like. The carrier 5G terminal 203 outputs the received data to the train gateway 204, and transmits the data acquired from the train gateway 204 to the base station 101.

Note that the on-board wireless device 200 may be configured to include only the local 5G terminal 202 or the carrier 5G terminal 203. That is, the on-board wireless device 200 can be configured to include the local 5G terminal 202 but not to include the carrier 5G terminal 203, or to include the carrier 5G terminal 203 but not to include the local 5G terminal 202. In the following description, the local 5G terminal 202 and the carrier 5G terminal 203 may be referred to as a first communication unit, and the sidelink terminal 201 may be referred to as a second communication unit. In addition, the sidelink terminal 201, the local 5G terminal 202, and the carrier 5G terminal 203 may be simply referred to as a communication unit.

The spectrum analyzer 207 measures the number of multipaths, the attenuation amount, and the like for data transmitted from the base station 101 and the like as the communication quality in the on-board wireless device 200. That is, the spectrum analyzer 207 measures the communication quality of 5G wireless communication in the local 5G terminal 202 and the carrier 5G terminal 203. The spectrum analyzer 207 outputs the measurement result of the communication quality to the determination unit 206.

The determination unit 206 is connected to the train gateway 204, the storage unit 205, the spectrum analyzer 207, the train control device 208, and the front monitoring camera 209. As information indicating the communication environment of the train 100, the determination unit 206 can acquire the information stored in the storage unit 205 from the storage unit 205, acquire the measurement result of the communication quality from the spectrum analyzer 207, acquire the speed information of the train 100 and the position information of the train 100 from the train control device 208, and acquire a video of the traveling direction of the train 100 captured by the front monitoring camera 209 from the front monitoring camera 209. As will be described later, the on-board wireless device 200 can acquire operation management information from an operation management device in a command center that manages the operation of the train 100 via a 5G core or the like. The operation management information includes, as information indicating the communication environment of the train 100, for example, information such as position information of another train 100, speed information of another train 100, position information of the base station 101, line information indicating the line shape and gradient of the line on which the train 100 travels, the type of the train 100, information on the expected speed expected at each point of the line on which the train 100 travels according to the type of the train 100, and tunnel information. The tunnel information includes, for example, information regarding the tunnel 102 through which the train 100 passes including the length, the cross-sectional area of the tunnel 102, the material of the tunnel 102, and a structure indicating whether the inbound line 103 and the outbound line 104 have the same tunnel 102 or different tunnels 102. The determination unit 206 determines a communication unit to be used for transmission and reception of data based on the communication environment of the train 100 at the position of the train 100. The determination unit 206 may use only one piece of the above information or a plurality of pieces of information as the information indicating the communication environment of the train 100.

The storage unit 205 stores the information indicating the communication environment of the train 100 acquired by the determination unit 206 and used by the determination unit 206 in determining the communication unit to be used for transmission and reception of data. For example, for each position of the train 100 indicated by the position information of the train 100, the storage unit 205 stores information such as the speed of the train 100, a past measurement result of the communication quality by the spectrum analyzer 207, and a past video in the traveling direction of the train 100 captured by the front monitoring camera 209. The determination unit 206 causes the storage unit 205 to store the information indicating the communication environment of the train 100 used in determining the communication unit to be used for transmission and reception of data.

The train gateway 204 is connected to the sidelink terminal 201, the local 5G terminal 202, the carrier 5G terminal 203, the determination unit 206, and the app server 210. In FIG. 4, the train gateway 204 is denoted by train gateway (GW) 204. For example, the train gateway 204 outputs data received by the sidelink terminal 201, the local 5G terminal 202, or the carrier 5G terminal 203 to the app server 210, and performs control to transmit the data acquired from the app server 210 from at least one of the sidelink terminal 201, the local 5G terminal 202, and the carrier 5G terminal 203 based on the determination result of the determination unit 206. The train gateway 204 is a communication control unit that controls transmission and reception of data in the sidelink terminal 201, the local 5G terminal 202, and the carrier 5G terminal 203.

The train gateway 204 performs the following four operations when using the sidelink terminal 201 and the local 5G terminal 202. As the first operation, the train gateway 204 causes the sidelink terminal 201 to transmit the data acquired from the app server 210. As the second operation, the train gateway 204 causes the sidelink terminal 201 to transmit the data received by the sidelink terminal 201. As the third operation, the train gateway 204 performs schedule processing on the data received by the sidelink terminal 201 and causes the local 5G terminal 202 to transmit the data together with the data from the train. As the fourth operation, the train gateway 204 causes the local 5G terminal 202 to transmit the data acquired from the app server 210.

FIG. 5 is a diagram illustrating a flow of data transmitted and received by the on-board wireless device 200 according to the first embodiment. In FIG. 5, the SL path 211 corresponds to the first operation described above, the SL relay path 212 corresponds to the second operation described above, the path 213 from SL to L5G corresponds to the third operation described above, and the L5G path 214 corresponds to the fourth operation described above.

Similarly, the train gateway 204 performs the following four operations when using the sidelink terminal 201 and the carrier 5G terminal 203. As the first operation, the train gateway 204 causes the sidelink terminal 201 to transmit the data acquired from the app server 210. As the second operation, the train gateway 204 causes the sidelink terminal 201 to transmit the data received by the sidelink terminal 201. As the third operation, the train gateway 204 performs schedule processing on the data received by the sidelink terminal 201 and causes the carrier 5G terminal 203 to transmit the data together with the data from the train. As the fourth operation, the train gateway 204 causes the carrier 5G terminal 203 to transmit the data acquired from the app server 210.

Although not illustrated, a case where the train gateway 204 uses the sidelink terminal 201 and the carrier 5G terminal 203 can also be illustrated by a similar diagram by replacing the portion of the path related to the local 5G terminal 202 illustrated in FIG. 5 with the carrier 5G terminal 203.

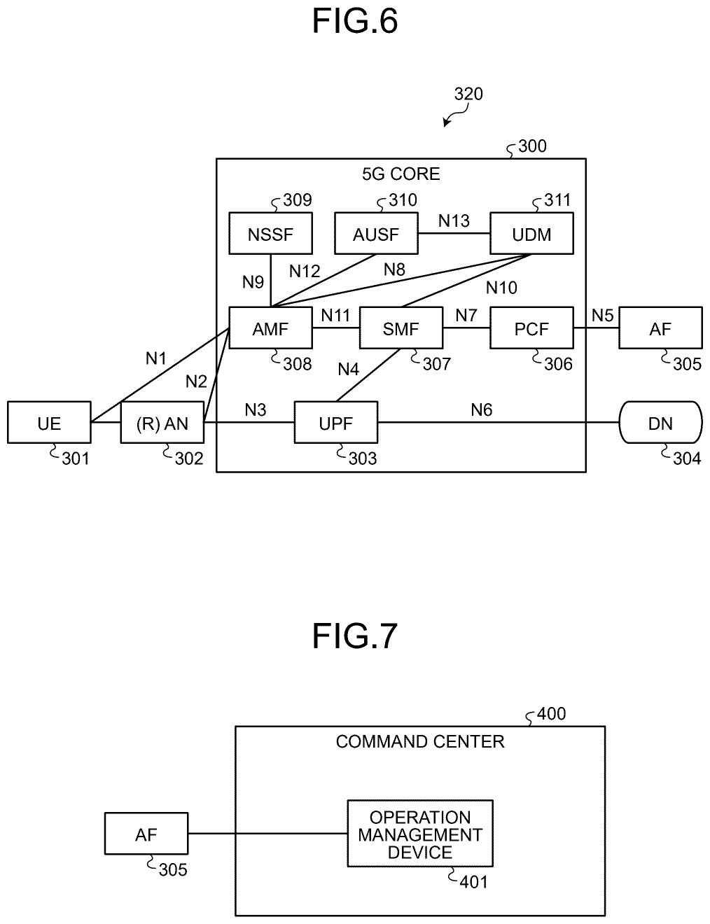

A connection relationship between the on-board wireless device 200 and the 5G core, AF, and the like will be described. FIG. 6 is a diagram illustrating an exemplary configuration of a 5G system 320 according to the first embodiment. The 5G system 320 includes a 5G core 300, a UE301, a (radio) access network ((R) AN)) 302, a data network (DN) 304, and an AF 305. In FIG. 6, the UE301 is the local 5G terminal 202 or the carrier 5G terminal 203 of the on-board wireless device 200. The (R) AN302 is the base station 101A or the base station 101B.

The 5G core 300 includes a server, dedicated hardware, and the like. The 5G core 300 includes a user plane function (UPF) 303 that performs packet transfer of user data, a policy control function (PCF) 306 that performs policy control, a session management function (SMF) 307 that performs session management, an access and mobility management function (AMF) 308 that performs location management, authentication, and the like of the UE301, a network slice selection function (NSSF) 309 that selects the SMF 307 for each slice, an authentication server function (AUSF) 310 for subscriber authentication, a unified data management (UDM) 311 that manages data related to the subscriber, and the like. In the 5G core 300, each internal configuration is connected to another configuration of the 5G core 300 or a configuration outside the 5G core 300 by the N1 interface to the N13 interface. The DN 304 is connected to the 5G core 300 using the N6 interface, and exchanges user data with the UPF 303.

The PCF 306 can be connected to the AF 305 via the N5 interface. The AF 305 is an external application server, and can acquire operation management information from an operation management device 401 in a command center 400 as illustrated in FIG. 7. FIG. 7 is a diagram illustrating a connection relationship between the AF 305 connected to the 5G core 300 and the command center 400 according to the first embodiment. The command center 400 is a facility that is installed on the ground and manages the operation of the train 100 using the operation management device 401. From the connection relationship illustrated in FIGS. 6 and 7, the local 5G terminal 202 or the carrier 5G terminal 203 of the on-board wireless device 200 can acquire the operation management information from the operation management device 401 in the command center 400 via the (R) AN 302, the 5G core 300, and the AF 305. The local 5G terminal 202 or the carrier 5G terminal 203 outputs the acquired operation management information to the determination unit 206 via the train gateway 204.

Since the operation management device 401 manages the operations of all the trains 100 in the control range, not only the position information and the speed information of another train 100 but also the position information and the speed information of the train 100 in which the on-board wireless device 200 performing communication is installed. Therefore, the on-board wireless device 200 can acquire the position information and the speed information of the train 100 in which the on-board wireless device 200 is installed from the train control device 208 or from the operation management device 401. Hereinafter, a case where the on-board wireless device 200 acquires the position information and the speed information of the train 100 in which the on-board wireless device 200 is installed from the train control device 208 will be described as an example.

An outline of wireless communication by sidelink in the on-board wireless device 200 will be described. The on-board wireless device 200 is instructed by the base station 101 regarding the synchronization timing, the available frequency pool, the relay path, and the like for the wireless communication by sidelink because of level 1, that is, an environment in which one or more terminals in the terminal group of the local 5G terminal 202 and the carrier 5G terminal 203 are connected to the base station 101. The on-board wireless device 200 as a connection destination by sidelink has a feature of sharing these pieces of information with the on-board wireless device 200 as a connection source by sidelink. Since the on-board wireless device 200 as a connection source by sidelink can perform communication at a timing synchronized with the base station 101, interference with another on-board wireless device 200 connected to the base station 101 can be prevented.

Next, an operation in which the determination unit 206 of the on-board wireless device 200 determines communication disconnection or the like in the local 5G terminal 202 or the carrier 5G terminal 203 will be described. Hereinafter, six specific cases will be described.

Case 1: Estimate shielding of wireless communication from the measurement result of the spectrum analyzer 207.

In the on-board wireless device 200, the spectrum analyzer 207 measures communication quality such as the number of multipaths and the attenuation amount for data transmitted from the base station 101, and outputs the measurement result of the communication quality to the determination unit 206. The determination unit 206 acquires the measurement result of the communication quality from the spectrum analyzer 207, and acquires position information and the like of the train 100 from the train control device 208. In addition, the determination unit 206 reads, from the storage unit 205, information on a past measurement result of the communication quality of wireless communication of the local 5G terminal 202 or the carrier 5G terminal 203 for each point of the line on which the train 100 travels.

The determination unit 206 estimates, as the information indicating the communication environment of the train 100, whether there is another train 100 that shields the wireless communication of the local 5G terminal 202 or the carrier 5G terminal 203 by using the information on the past measurement result of the communication quality of the wireless communication of the local 5G terminal 202 or the carrier 5G terminal 203 for each point of the line on which the train 100 travels, the current position information of the train 100, and the information on the measurement result of the communication quality of the wireless communication of the local 5G terminal 202 or the carrier 5G terminal 203 at the current position of the train 100. In response to estimating that there is another train 100 that shields wireless communication of the local 5G terminal 202 or the carrier 5G terminal 203, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203. Note that the determination unit 206 causes the storage unit 205 to store the measurement result of the communication quality acquired from the spectrum analyzer 207 and used in the current determination. As a result, the determination unit 206 can use the information used in the current determination for subsequent determinations.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

For example, the train gateway 204 duplicates the data acquired from the app server 210 and causes the local 5G terminal 202 or the carrier 5G terminal 203 and the sidelink terminal 201 to transmit the same data. In addition, the train gateway 204 causes the data received by the sidelink terminal 201 to be transmitted from the sidelink terminal 201, and also causes the local 5G terminal 202 or the carrier 5G terminal 203 to transmit the same data. The same applies to the following cases.

As a result, even when wireless communication with the base station 101 is shielded, the on-board wireless device 200 can start relay transmission to connect to the base station 101 via another train 100 by using the sidelink terminal 201.

Note that in response to estimating that there is no another train 100 that shields wireless communication of the local 5G terminal 202 or the carrier 5G terminal 203, the determination unit 206 determines that transmission and reception of data in the local 5G terminal 202 or the carrier 5G terminal 203 is continued, and outputs the determination result to the train gateway 204. Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

Here, the train gateway 204 performs control to achieve a state in which data can be received by the sidelink terminal 201 regardless of the determination result of the determination unit 206 so that data from the sidelink terminal 201 of the on-board wireless device 200 installed in another train 100 can be received. Therefore, actually, the train gateway 204 controls transmission of data in the sidelink terminal 201 based on the determination result of the determination unit 206. The same applies to the following cases.

In the example illustrated in FIG. 3, the on-board wireless device 200 of the train 100C can perform wireless communication with the base station 101B via the on-board wireless device 200 of the train 100A. The on-board wireless device 200 of the train 100A that has received the data from the on-board wireless device 200 of the train 100C can perform wireless communication with the base station 101B, and thus requests the base station 101B to allocate the frequency pool, and notifies the on-board wireless device 200 of the train 100C that is the relay destination of the frequency and the synchronization timing provided by the base station 101B. As a result, the on-board wireless device 200 of the train 100C can perform wireless communication with the base station 101B via the on-board wireless device 200 of the train 100A. The same applies to the following cases.

Case 2: Determine disconnection of wireless communication from line information indicating the line shape and gradient of the line on which the train 100 travels.

In the on-board wireless device 200, as described above, the determination unit 206 acquires the operation management information from the operation management device 401 in the command center 400 via the 5G core 300 and the like, and acquires the position information of the train 100 and the like from the train control device 208.

The determination unit 206 determines whether data can be transmitted and received between the local 5G terminal 202 or the carrier 5G terminal 203 and the base station 101 using line information indicating the line shape and gradient of the line on which the train 100 travels included in the operation management information and the position information of the train 100 as the information indicating the communication environment of the train 100. In consideration of the directivity of the antenna used by the local 5G terminal 202 or the carrier 5G terminal 203, for example, in a case where the base station 101 is out of the range in which data can be transmitted and received by the antenna due to continuation of a curve in the line on which the train 100 travels, the determination unit 206 determines that data becomes unable to be transmitted and received between the local 5G terminal 202 or the carrier 5G terminal 203 and the base station 101. In response to determining that transmission and reception of data is unavailable between the local 5G terminal 202 or the carrier 5G terminal 203 and the base station 101, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

As a result, even when wireless communication with the base station 101 is disconnected due to a change in line shape, gradient, or the like of the line, the on-board wireless device 200 can start relay transmission to connect to the base station 101 via another train 100 by using the sidelink terminal 201.

Note that in response to determining that data can be transmitted and received between the local 5G terminal 202 or the carrier 5G terminal 203 and the base station 101, the determination unit 206 determines that transmission and reception of data in the local 5G terminal 202 or the carrier 5G terminal 203 is continued, and outputs the determination result to the train gateway 204.

Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

Case 3: Determine disconnection of wireless communication according to the distance between the train 100 and the base station 101.

In the on-board wireless device 200, as described above, the determination unit 206 acquires the operation management information from the operation management device 401 in the command center 400 via the 5G core 300 and the like, and acquires the position information of the train 100 and the like from the train control device 208.

The determination unit 206 uses the position information of the base station 101 included in the operation management information and the position information of the train 100 as the information indicating the communication environment of the train 100 to confirm whether the distance between the base station 101 and the train 100 is equal to or greater than a prescribed threshold. As described above, in the on-board wireless device 200, the antennas of the local 5G terminal 202 and the carrier 5G terminal 203 have directivity in the traveling direction of the train 100. Therefore, for example, in a case where the base station 101 is installed at a station, immediately after the train 100 departs from the station, the distance between the train 100 and the next station where the base station 101 is installed is long, and thus the on-board wireless device 200 may suffer communication disconnection. In order to avoid such a situation, when the distance between the base station 101 and the train 100 is equal to or greater than a prescribed threshold, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203. Note that the threshold is determined in advance by a person in charge in the railway company that operates the train 100 or the like according to the performance of the local 5G terminal 202 and the carrier 5G terminal 203.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

As a result, even when wireless communication with the base station 101 is disconnected due to the long distance to the base station 101, the on-board wireless device 200 can start relay transmission to connect to the base station 101 via another train 100 by using the sidelink terminal 201.

Note that when the distance between the base station 101 and the train 100 is less than the prescribed threshold, the determination unit 206 determines that transmission and reception of data in the local 5G terminal 202 or the carrier 5G terminal 203 is continued, and outputs the determination result to the train gateway 204. Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

Case 4: Determine disconnection of wireless communication according to train type.

In the on-board wireless device 200, as described above, the determination unit 206 acquires the operation management information from the operation management device 401 in the command center 400 via the 5G core 300 and the like, and acquires the position information of the train 100 and the like from the train control device 208.

The determination unit 206 uses, as the information indicating the communication environment of the train 100, the position information of the base station 101, the type of the train 100, the information on the expected speed expected at each point of the line on which the train 100 travels according to the type of the train 100, the speed information of the train 100, and the position information of the train 100 to confirm whether the speed at which the train 100 passes by the base station 101 is equal to or greater than a prescribed threshold. As described above, in a case where the base station 101 is installed at a station, if the train 100 stops at the station, the local 5G terminal 202 or the carrier 5G terminal 203 of the on-board wireless device 200 can easily perform wireless communication with the base station 101. However, in a case where a local train, a rapid train, an express train, a limited express train, or the like can be set as the type of the train 100, and the type of the train 100 is an express train, a limited express train, or the like, if the train 100 passes without stopping at the station, the local 5G terminal 202 or the carrier 5G terminal 203 of the on-board wireless device 200 may not be able to perform wireless communication with the base station 101 installed at the station. In order to avoid such a situation, when the speed at which the train 100 passes by the base station 101 is equal to or greater than a prescribed threshold, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203. Note that the threshold is determined in advance by a person in charge in the railway company that operates the train 100 or the like according to the performance of the local 5G terminal 202 and the carrier 5G terminal 203.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

As a result, even when the train 100 in which the on-board wireless device 200 is installed passes by a station in which the base station 101 is installed, the on-board wireless device 200 can start relay transmission to connect to the base station 101 via another train 100 by using the sidelink terminal 201.

Note that when the speed at which the train 100 passes by the base station 101 is less than the prescribed threshold, the determination unit 206 determines that transmission and reception of data in the local 5G terminal 202 or the carrier 5G terminal 203 is continued, and outputs the determination result to the train gateway 204. Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

Case 5: Determine disconnection of wireless communication from line information and tunnel information.

In the on-board wireless device 200, as described above, the determination unit 206 acquires the operation management information from the operation management device 401 in the command center 400 via the 5G core 300 and the like, and acquires the position information of the train 100 and the like from the train control device 208.

The determination unit 206 decides whether to cause the sidelink terminal 201 to transmit and receive data by using, as information indicating the communication environment of the train 100, tunnel information regarding the tunnel 102 through which the train 100 passes including length, cross-sectional area, material, and structure information indicating whether the inbound line 103 and the outbound line 104 have the same tunnel 102 or different tunnels 102, line information indicating the line shape and gradient of the line on which the train 100 travels, and position information of the train 100. For example, in a case where the tunnel 102 has a structure in which the inbound line 103 and the outbound line 104 have separate tunnels 102, relay transmission via another train 100 cannot be performed, and thus the determination unit 206 does not determine that the sidelink terminal 201 transmits and receives data. In addition, in a case where the cross-sectional area of the tunnel 102 is narrow, shielding by another train 100 is larger than in a case where the cross-sectional area of the tunnel 102 is wide, and thus the determination unit 206 determines that data is transmitted and received also by the sidelink terminal 201 early. In addition, in a case where the wall surface inside the tunnel 102 is made of concrete, reflection is less than in a case where the wall surface inside the tunnel 102 is made of metal, and thus the determination unit 206 determines that data is transmitted and received also by the sidelink terminal 201 early. In addition, in a case where the line information indicates that the line on which the train 100 travels has a curve or a gradient, the determination unit 206 can decide whether data is transmitted and received by the sidelink terminal 201 according to the length of the tunnel 102. In response to deciding to cause the sidelink terminal 201 to transmit and receive data, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

As a result, even when the train 100 passes through the tunnel 102, the on-board wireless device 200 can start relay transmission to connect to the base station 101 via another train 100 by appropriately using the sidelink terminal 201 according to the structure of the tunnel 102 or the like.

Note that in response to deciding not to cause the sidelink terminal 201 to transmit and receive data, the determination unit 206 determines that transmission and reception of data in the local 5G terminal 202 or the carrier 5G terminal 203 is continued, and outputs the determination result to the train gateway 204. Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

Case 6: Share information on communication disconnection with the on-board wireless device 200 of another train 100.

As described in Cases 1 to 5, in a case where the determination unit 206 determines that data is transmitted and received also by the sidelink terminal 201 together with the local 5G terminal 202 or the carrier 5G terminal 203, there is a possibility that the on-board wireless device 200 installed in another train 100 traveling near the train 100 in which the on-board wireless device 200 is installed is also in a similar communication state. Therefore, the on-board wireless device 200 installed in the train 100 may instruct the on-board wireless device 200 installed in another train 100 to transmit and receive data also by the sidelink terminal 201 together with the local 5G terminal 202 or the carrier 5G terminal 203.

Specifically, when the determination unit 206 of the on-board wireless device 200 installed in the train 100 determines that data is transmitted and received also by the sidelink terminal 201 together with the local 5G terminal 202 or the carrier 5G terminal 203, the determination unit 206 outputs, to the train gateway 204, information indicating the communication environment of the train 100 stored in the storage unit 205 and a redundancy instruction indicating that data is transmitted and received also by the sidelink terminal 201 together with the local 5G terminal 202 or the carrier 5G terminal 203, for the on-board wireless device 200 installed in another train 100.

The train gateway 204 causes the local 5G terminal 202 or the carrier 5G terminal 203 to transmit the information indicating the communication environment of the train 100 and the redundancy instruction acquired from the determination unit 206 to the base station 101, with the on-board wireless device 200 installed in another train 100 as a destination. In addition, in response to acquiring, from the on-board wireless device 200 installed in another train 100, the information indicating the communication environment of the other train 100 stored in the storage unit 205 of the on-board wireless device 200 installed in the other train 100, and the redundancy instruction indicating that data is transmitted and received also by the sidelink terminal 201 together with the local 5G terminal 202 or the carrier 5G terminal 203, the train gateway 204 outputs, to the determination unit 206, the information indicating the communication environment of the other train 100 stored in the storage unit 205 of the on-board wireless device 200 installed in the other train 100. The train gateway 204 performs control such that data is transmitted and received by the local 5G terminal 202 or the carrier 5G terminal 203 and the sidelink terminal 201 based on the redundancy instruction from the on-board wireless device 200 installed in the other train 100.

Upon acquiring the information indicating the communication environment of the other train 100 stored in the storage unit 205 of the on-board wireless device 200 installed in the other train 100 from the train gateway 204, the determination unit 206 may store the acquired information in the storage unit 205 and use the acquired information for the determination described in Cases 1 to 5.

As a result, the on-board wireless device 200 can cause the on-board wireless device 200 installed in the other train 100 to start relay transmission early, and the reliability of transmission and reception of data can be improved. Note that the on-board wireless device 200 that has determined to transmit and receive data also by the sidelink terminal 201 together with the local 5G terminal 202 or the carrier 5G terminal 203 can also transmit a redundancy instruction from the sidelink terminal 200 to the on-board wireless device 200 installed in the other train 100 as long as the on-board wireless device 201 installed in the other train 100 can receive data by sidelink.

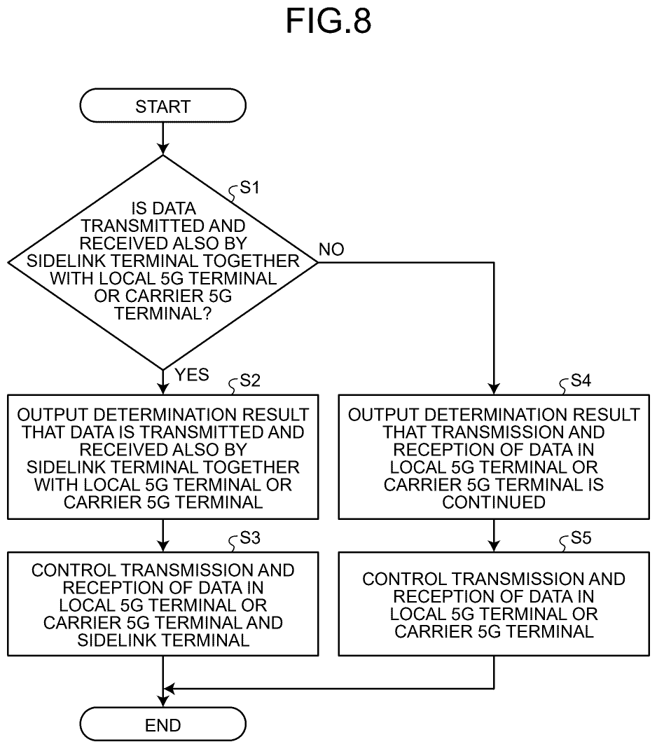

FIG. 8 is a flowchart illustrating the operation of the on-board wireless device 200 according to the first embodiment. The determination unit 206 determines a communication unit to be used for transmission and reception of data based on the communication environment of the train 100 at the position of the train 100. Specifically, the determination unit 206 determines whether to transmit and receive data also by the sidelink terminal 201 together with the local 5G terminal 202 or the carrier 5G terminal 203 (step S1). In response to determining that data is transmitted and received also by the sidelink terminal 201 together with the local 5G terminal 202 or the carrier 5G terminal 203 (step S1: Yes), the determination unit 206 outputs, to the train gateway 204, the determination result that data is transmitted and received also by the sidelink terminal 201 together with the local 5G terminal 202 or the carrier 5G terminal 203 (step S2). In response to deciding not to cause the sidelink terminal 201 to transmit and receive data (step S1: No), the determination unit 206 outputs, to the train gateway 204, the determination result that transmission and reception of data in the local 5G terminal 202 or the carrier 5G terminal 203 is continued (step S4).

The train gateway 204 controls transmission and reception of data in the local 5G terminal 202 or the carrier 5G terminal 203 and the sidelink terminal 201 based on the determination result of the determination unit 206. Specifically, in response to acquiring the determination result from the determination unit 206 that the data is transmitted and received also by the sidelink terminal 201 together with the local 5G terminal 202 or the carrier 5G terminal 203, the train gateway 204 controls transmission and reception of data in the local 5G terminal 202 or the carrier 5G terminal 203 and the sidelink terminal 201 such that the data is transmitted and received by the local 5G terminal 202 or the carrier 5G terminal 203 and the sidelink terminal 201 (step S3). Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203 (step S5).

Subsequently, the hardware configuration of the on-board wireless device 200 will be described. In the on-board wireless device 200, the sidelink terminal 201 is a communication device that performs wireless communication by sidelink. The local 5G terminal 202 and the carrier 5G terminal 203 are communication devices that perform wireless communication by 5G. The storage unit 205 is a memory. The spectrum analyzer 207 is a measuring instrument that measures communication quality in the on-board wireless device 200. The train gateway 204 and the determination unit 206 are implemented by processing circuitry. The processing circuitry may be a memory and a processor that executes a program stored in the memory, or may be dedicated hardware. The processing circuitry is also called a control circuit.

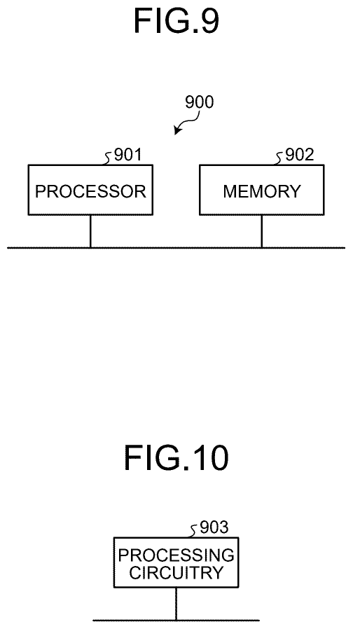

FIG. 9 is a diagram illustrating an exemplary configuration of processing circuitry 900 in the case that the processing circuitry that implements the on-board wireless device 200 according to the first embodiment is implemented by a processor 901 and a memory 902. The processing circuitry 900 illustrated in FIG. 9 is a control circuit and includes the processor 901 and the memory 902. In a case where the processing circuitry 900 is configured with the processor 901 and the memory 902, each function of the processing circuitry 900 is implemented by software, firmware, or a combination of software and firmware. Software or firmware is described as a program and stored in the memory 902. In the processing circuitry 900, the processor 901 reads and executes the program stored in the memory 902, thereby implementing each function. That is, the processing circuitry 900 includes the memory 902 for storing the program that results in the processing of the on-board wireless device 200. It can also be said that this program is a program for causing the on-board wireless device 200 to execute each function implemented by the processing circuitry 900. This program may be provided by a storage medium in which the program is stored, or may be provided by other means such as a communication medium. The program can also be said to be a program that causes the on-board wireless device 200 to execute a first step in which the determination unit 206 determines a communication unit to be used for transmission and reception of data based on the communication environment of the train 100 at the position of the train 100, and a second step in which the train gateway 204 controls transmission and reception of data in the first communication unit and the second communication unit based on the determination result of the determination unit 206.

The processor 901 is exemplified by a central processing unit (CPU), a processing device, an arithmetic device, a microprocessor, a microcomputer, or a digital signal processor (DSP). Examples of the memory 902 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

FIG. 10 is a diagram illustrating an example of processing circuitry 903 in the case that the processing circuitry that implements the on-board wireless device 200 according to the first embodiment is implemented by dedicated hardware. For example, the processing circuitry 903 illustrated in FIG. 10 is a single circuit, a composite circuit, a programmed processor, a parallel programmed processor, an application specific integrated circuit (ASIC), a field programmable gate array (FPGA), or a combination thereof. A part of the processing circuitry may be implemented by dedicated hardware, and the other part may be implemented by software or firmware. In this manner, the processing circuitry can implement each of the above-described functions by means of dedicated hardware, software, firmware, or a combination thereof.

As described above, according to the present embodiment, when the train 100 is traveling in the tunnel 102 and cannot directly perform wireless communication with the base station 101, the on-board wireless device 200 installed in the train 100 performs wireless communication with the base station 101 via the on-board wireless device 200 installed in another train 100 by means of wireless communication by sidelink. As a result, the on-board wireless device 200 can reduce the frequency of communication disconnection from the base station 101 in the train 100 capable of directly communicating with the base station 101 in one direction of the route on which the train 100 travels.

The present embodiment assumes the case illustrated in FIG. 3 as a case where the on-board wireless device 200 installed in the train 100 performs wireless communication with the base station 101 via the on-board wireless device 200 installed in another train 100, but is not limited thereto. For example, when the train 100 travels on a quadruple-track line, the on-board wireless device 200 installed in the train 100 can also perform wireless communication with the base station 101 via the on-board wireless devices 200 installed in two or more other trains 100.

### Second Embodiment

In the first embodiment, it is assumed that the train 100 equipped with the on-board wireless device 200 is in operation and is traveling in the tunnel 102. In the second embodiment, a case where the train 100 equipped with the on-board wireless device 200 has finished operation and is left in a train yard will be described.

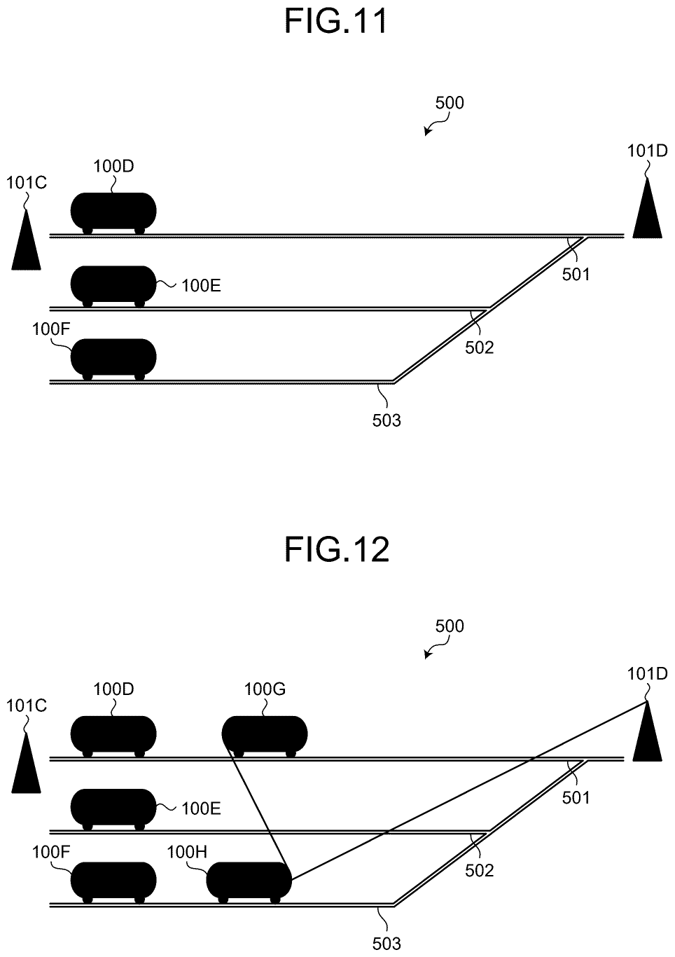

FIG. 11 is a first diagram illustrating a state in which the trains 100 equipped with the on-board wireless devices 200 are left in a train yard 500 according to the second embodiment. FIG. 12 is a second diagram illustrating a state in which the trains 100 equipped with the on-board wireless devices 200 are left in the train yard 500 according to the second embodiment. Trains 100D, 100E, 100F, 100G, and 100H have the same configuration as the trains 100A, 100B, and 100C in the first embodiment, and are each equipped with the on-board wireless device 200. Similarly to the trains 100A, 100B, and 100C, the trains 100D, 100E, 100F, 100G, and 100H may be referred to as the train 100 when not distinguished. The train yard 500 includes storage lines 501, 502, and 503 and can store a plurality of trains 100. In the train yard 500, a base station 101C is installed at a track end of the vehicle yard 500, and a base station 101D is installed near a place where the train 100 can enter and leave the train yard 500. Similarly to the base stations 101A and 101B in the first embodiment, the base stations 101C and 101D may be referred to as the base station 101 when not distinguished.

In the example illustrated in FIG. 11, the on-board wireless device 200 installed in the train 100 can communicate with the base station 101C installed in front since the traveling direction of the train 100 is the direction of the base station 101C when the train 100 enters the train yard 500. In addition, the on-board wireless device 200 installed in the train 100 can communicate with the base station 101D installed in front since the traveling direction of the train 100 is the direction of the base station 101D when the train 100 leaves the train yard 500.

On the other hand, as illustrated in FIG. 12, in a case where a plurality of trains 100 are left in one storage line 501, another train 100D may exist in front of the train 100G. In such a case, the on-board wireless device 200 installed in the train 100G becomes unable to communicate with the base station 101C. Therefore, in the second embodiment, the on-board wireless device 200 installed in the train 100G determines the presence or absence of the preceding train 100 using the front monitoring camera 209 installed in the train 100G. When the train 100D is present ahead, the on-board wireless device 200 installed in the train 100G starts transmission and reception of data by the sidelink terminal 201 and communicates with the base station 101D via the train 100H as illustrated in FIG. 12, thereby avoiding communication disconnection.

Specifically, the determination unit 206 uses a video acquired from the front monitoring camera 209 that monitors the traveling direction of the train 100 as the information indicating the communication environment of the train 100 to confirm whether another train 100 exists within a prescribed range from the train 100 in the traveling direction of the train 100. Even when another train 100 exists in front of the train 100, if the distance between the train 100 and the other train 100 is long, there is a possibility that the other train 100 does not shield the wireless communication of the on-board wireless device 200 of the train 100. When another train 100 exists within a prescribed range from the train 100 in the traveling direction of the train 100, the determination unit 206 determines that data is transmitted and received also by the sidelink terminal 201 together with the local 5G terminal 202 or the carrier 5G terminal 203, and outputs the determination result to the train gateway 204. In response to determining that data is transmitted and received also by the sidelink terminal 201 together with the local 5G terminal 202 or the carrier 5G terminal 203, the determination unit 206 instructs the train gateway 204 to transmit the same data from the sidelink terminal 201 and the local 5G terminal 202 or the carrier 5G terminal 203.

The train gateway 204 controls transmission and reception of data in the local 5G terminal 202 or the carrier 5G terminal 203 and the sidelink terminal 201 such that data is transmitted and received in the local 5G terminal 202 or the carrier 5G terminal 203 and the sidelink terminal 201 based on the determination result obtained from the determination unit 206 that data is transmitted and received also by the sidelink terminal 201 together with the local 5G terminal 202 or the carrier 5G terminal 203. In addition, the train gateway 204 duplicates the data to be transmitted based on an instruction from the determination unit 206, and causes the sidelink terminal 201 and the local 5G terminal 202 or the carrier 5G terminal 203 to transmit the same data.

As a result, the on-board wireless device 200 can start relay transmission to connect to the base station 101 via another train 100 by using the video acquired from the front monitoring camera 209.

Note that when another train 100 does not exist within a prescribed range from the train 100 in the traveling direction of the train 100, the determination unit 206 determines that transmission and reception of data in the local 5G terminal 202 or the carrier 5G terminal 203 is continued, and outputs the determination result to the train gateway 204. Upon acquiring the determination result indicating that transmission and reception of data in the local 5G terminal 202 or the carrier 5G terminal 203 is continued from the determination unit 206, the train gateway 204 controls transmission and reception of data in the local 5G terminal 202 or the carrier 5G terminal 203 such that transmission and reception of data is continued in the local 5G terminal 202 or the carrier 5G terminal 203.

As described above, according to the present embodiment, the on-board wireless device 200 can obtain the same effects as those in the first embodiment even in a situation where the train 100 in which the on-board wireless device 200 is installed is left in the train yard 500.

The on-board wireless device according to the present disclosure can achieve the effect of reducing the frequency of communication disconnection from a base station in a train capable of directly communicating with the base station in one direction of the route on which the train travels.

The configurations described in the above-mentioned embodiments indicate examples. The embodiments can be combined with another well-known technique and with each other, and some of the configurations can be omitted or changed in a range not departing from the gist.

What is claimed is:

1. An on-board wireless device to be installed in a train, the on-board wireless device comprising:
a first transceiver that is a transceiver capable of transmitting and receiving data to and from a base station by a wireless communication scheme of a 5th generation mobile communication system using an antenna having directivity in a traveling direction of the train;
a second transceiver that is a transceiver capable of transmitting and receiving data to and from an on-board wireless device installed in an other train using wireless communication by sidelink;
a determination circuitry to determine a transceiver to be used for transmission and reception of data based on a communication environment of the train at a position of the train; and
a communication controller to control transmission and reception of data in the first transceiver and the second transceiver based on a determination result of the determination circuitry, wherein
the determination circuitry uses, as information indicating the communication environment of the train, information on a past measurement result of communication quality of wireless communication of the first transceiver for each point of a line on which the train travels, current position information of the train, and information on a measurement result of communication quality of wireless communication of the first transceiver at a current position of the train, and in response to estimating that the other train that shields wireless communication of the first transceiver exists, determines that data is transmitted and received also by the second transceiver together with the first transceiver, and
the communication controller performs control such that data is transmitted and received by the first transceiver and the second transceiver based on the determination result.

2. The on-board wireless device according to claim 1, wherein
the determination circuitry uses a video acquired from a front monitoring camera that monitors the traveling direction of the train as information indicating the communication environment of the train, and in response to determining that the other train exists within a prescribed range from the train in the traveling direction of the train, determines that data is transmitted and received also by the second transceiver together with the first transceiver, and
the communication controller performs control such that data is transmitted and received by the first transceiver and the second transceiver based on the determination result.

3. The on-board wireless device according to claim 1, wherein
the determination circuitry uses line information indicating a line shape and a gradient of a line on which the train travels and position information of the train as information indicating the communication environment of the train, and in response to determining that transmission and reception of data is unavailable between the first transceiver and the base station, determines that data is transmitted and received also by the second transceiver together with the first transceiver, and
the communication controller performs control such that data is transmitted and received by the first transceiver and the second transceiver based on the determination result.

4. The on-board wireless device according to claim 1, wherein
the determination circuitry uses position information of the base station and position information of the train as information indicating the communication environment of the train, and in response to determining that a distance between the base station and the train is equal to or greater than a prescribed threshold, determines that data is transmitted and received also by the second transceiver together with the first transceiver, and
the communication controller performs control such that data is transmitted and received by the first transceiver and the second transceiver based on the determination result.

5. The on-board wireless device according to claim 1, wherein
the determination circuitry uses, as information indicating the communication environment of the train, position information of the base station, type of the train, information on an expected speed expected at each point of a line on which the train travels according to the type of the train, speed information of the train, and position information of the train, and in response to determining that a speed at which the train passes by the base station is equal to or greater than a prescribed threshold, determines that data is transmitted and received also by the second transceiver together with the first transceiver, and
the communication controller performs control such that data is transmitted and received by the first transceiver and the second transceiver based on the determination result.

6. The on-board wireless device according to claim 1, wherein
the determination circuitry uses, as information indicating the communication environment of the train, tunnel information regarding a tunnel through which the train passes including length, cross-sectional area, material, and structure information indicating whether an inbound line and an outbound line have a same tunnel or different tunnels, line information indicating a line shape and a gradient of a line on which the train travels, and position information of the train, and in response to deciding to cause the second transceiver to transmit and receive data, determines that data is transmitted and received also by the second transceiver together with the first transceiver, and
the communication controller performs control such that data is transmitted and received by the first transceiver and the second transceiver based on the determination result.

7. The on-board wireless device according to claim 1, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.

8. The on-board wireless device according to claim 2, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.

9. The on-board wireless device according to claim 3, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.

10. The on-board wireless device according to claim 4, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.

11. The on-board wireless device according to claim 5, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.

12. The on-board wireless device according to claim 6, comprising:
a storage circuitry to store information indicating a communication environment of the train used by the determination circuitry in determining a transceiver to be used for transmission and reception of data, wherein the determination circuitry causes the storage circuitry to store the information indicating the communication environment of the train used by the determination circuitry in determining the transceiver to be used for transmission and reception of data,
in response to determining that data is transmitted and received also by the second transceiver together with the first transceiver, the determination circuitry outputs, to the communication controller, information indicating the communication environment of the train stored in the storage circuitry and a redundancy instruction indicating that data is transmitted and received also by the second transceiver together with the first transceiver, for the on-board wireless device installed in the other train, and
the communication controller causes the first transceiver to transmit the information indicating the communication environment of the train and the redundancy instruction acquired from the determination circuitry to the base station, with the on-board wireless device installed in the other train as a destination, and in response to acquiring, from the on-board wireless device installed in the other train, the information indicating the communication environment of the other train stored in the storage circuitry of the on-board wireless device installed in the other train, and the redundancy instruction indicating that data is transmitted and received also by the second transceiver together with the first transceiver, outputs, to the determination circuitry, the information indicating the communication environment of the other train stored in the storage circuitry of the on-board wireless device installed in the other train, and performs control such that data is transmitted and received by the first transceiver and the second transceiver based on the redundancy instruction from the on-board wireless device installed in the other train.
